(19) United States
(12) Patent Application Publication
(10) Pub. No.: US 2023/0416559 A1
(43) Pub. Date: Dec. 28, 2023

(54) Tyre Dressing Composition

(71) Applicant: Sasol (USA) Corporation, Houston, TX (US)

(72) Inventors: Gabriel Ortego, Lake Charles, LA (US); George Smith, Westlake, LA (US)

(21) Appl. No.: 18/338,289

(22) Filed: Jun. 20, 2023

Related U.S. Application Data
(60) Provisional application No. 63/354,419, filed on Jun. 22, 2022.

(51) Int. Cl. C09D 171/02; C08G 65/26; C08G 65/332; C09D 5/02

(52) U.S. Cl. CPC C09D 171/02; C08G 65/2609; C08G 65/3322; C09D 5/021

(57) ABSTRACT

Disclosed are compositions, and articles containing the composition, where the composition comprises glycerine alkoxylates and/or glyceride esters, obtained by transesterification of seed oil, and their use to enhance the combined gloss index of surfaces. More specifically the compositions are disclosed for the purpose of using a tyre-dressing system to enhance the sidewall aesthetics of tyres without requiring the use of silicone oils.

### CROSS REFERENCE TO RELATED APPLICATION

This application claims priority to U.S. Application No. 63/354,419 filed on Jun. 22, 2022 the disclosure of which is incorporated herein by reference for all purposes.

### FIELD OF THE INVENTION

This invention relates to a tyre dressing composition and more specifically the invention relates to a tyre dressing composition for enhancing an attribute known as the combined gloss index of an exposed elastomeric surface notably that of a rubber-based tyre, which composition is non-silicone based.

### BACKGROUND TO THE INVENTION

The external surfaces of tyres, more specifically the side walls are vulnerable to wear and weathering effects that result from exposure to sunshine, wind, rain and abrasion from dirt or other any physical and chemical agents during use over the lifecycle of a tyre. Tyre dressing compositions are typically used to reduce and/or counteract the effects thereby restoring the external surface from a dull weathered appearance to a glossy and attractive appearance.

In the field, it is common practise to use tyre-dressing compositions containing silicone oils. Typically, a solution or dispersion of silicone oil or wax in an organic solvent or as an aqueous emulsion prepared therefrom with the aid of a surfactant are generally employed as tyre dressing compositions. Conventional silicone fluid-based tyre dressing compositions bring an acceptable level of glossiness and improved water proofing capabilities to the tyre but are however susceptible to weathering agents and benefits are quickly lost in the typical weathered conditions. Apart from being an expensive component of the composition, there is a perception from the market that silicone fluid-based tyre dressing compositions are environmentally unfriendly and in certain instances when present may negatively interfere with other activities, notably car body repair and paint workshops because of their negative effects on spray painting operations. The applicant is aware of a market need for non-silicone fluid-based tyre dressing composition.

A recently published patent application, US20200131395A1, incorporated herein by reference for all purposes, discloses a tyre dressing composition that includes petroleum distillates in which a polybutene or isobutene/butene copolymer is dissolved to form a clear solution. In a water-based approach, the polybutene or isobutene/butene copolymer is emulsified by use of a surfactant. However there remains a need to further develop and propose alternative systems that can responds to the market needs including demands of materials that are friendlier to the environment and biodegradable.

It is an object of the invention to provide for a non-silicone-based, environmentally friendly, tyre dressing composition that enhances the surface appearance, especially gloss, of the sidewall of a natural rubber-based elastomer such as for example and notably a pneumatic tyre as typically used in transportation applications.

### SUMMARY OF THE INVENTION

In a first aspect of this disclosure, the invention relates to a tyre dressing composition intended for use in a tyre dressing method, said composition comprising an alcohol alkoxylate polymer corresponding to formula (1):

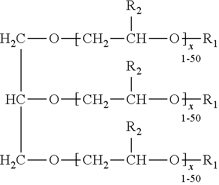

wherein:
each R₁ independently represents a hydrogen atom or an acyl moiety (—CO—R) where R is an alkyl or alkenyl group moiety constituted by at least 6, and up to 18 carbons atoms; R₂ represent a hydrogen atom, methyl (—CH₃) or ethyl (—CH₂CH₃) moiety; and each X independently represents an integer of from 1 to 50 and wherein the sum of all X present is from 1 to 100.

In another aspect, the invention relates to a method of using a tyre dressing composition as described hereinabove, the method comprising:
cleaning a target tyre sidewall;
applying a thin film coating of the said composition on said tyre sidewall and allowing the surface to dry, and optionally applying a second coating of the composition to the tyre sidewall.

In a yet another aspect, the invention relates to an article being a dispenser unit containing a tyre-dressing composition as described hereinabove.

In a yet another aspect, the invention relates to the use of a composition as hereinbefore described as a tyre dressing composition and the dressing of a tyre sidewall.

The inventors have surprisingly discovered that the tyre dressing composition comprising such an alcohol alkoxylate polymer provides for enhancement of the of the glossiness index of a natural rubber-based surface and permits the formulation of a tyre dressing system without the need to incorporate a silicone oil to attain an attractive glossiness index.

### DETAILED DESCRIPTION OF THE INVENTION

As mentioned, the tyre dressing composition intended for use in a tyre dressing method comprises an alcohol alkoxylate polymer corresponding to formula (I):

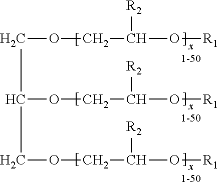

wherein:
   each R₁ independently represents a hydrogen atom or an acyl moiety (—CO—R) for which R is an alkyl or alkenyl moiety constituted by at least 6, and up to 18 carbons atoms;
   R₂ represent a hydrogen atom, a methyl (—CH₃) or an ethyl (—CH₂CH₃) moiety; and each X independently represents an integer of from 1 to 50 and wherein the sum of all X present is from 1 to 100.

The sum of all integers for “X” of formula (I), in a preferred embodiment is from to 80, and more preferably from 10 to 60.

In one aspect of the invention, the alcohol alkoxylate polymer comprises one or more glycerine alkoxylates as represented by formula (I) wherein R₁ is hydrogen and R₂ is a hydrogen or methyl moiety; R₂ is preferably hydrogen.

In another aspect of the invention, the alcohol alkoxylate polymer comprises one or more glyceride esters represented by formula (I) when at least at least one R₁ is an acyl moiety (—CO—R) with R being defined as above; and R₂ is a hydrogen or methyl moiety; R₂ is preferably hydrogen.

For the presently disclosed invention; preferably, the alcohol alkoxylate is produced by reaction over a narrow range ethoxylation catalyst, more preferably over a calcium-containing ethoxylation catalyst providing for narrow range ethoxylated alcohols. Such catalysts and use thereof to produce ethoxylated alcohols are known to the person skilled in the art and exemplified by the teachings of, for example, U.S. Pat. No. 4,754,075, the disclosure of which is incorporated herein by reference for all purposes. Exemplary of a suitable calcium-containing ethoxylation catalyst is the proprietary catalyst system developed by Sasol (USA) Corporation and as disclosed in U.S. Pat. Nos. 4,775,653; 4,835,321; 5,220,077; 5,626,121; 8,329,609 and 9,802,879, the disclosures of which are all incorporated herein by reference for all purposes.

In yet another, and preferred, aspect, the alcohol alkoxylate polymer is a mixture comprising (i) a glyceride ester represented by formula (I) when at least one R₁ is an acyl moiety (—CO—R) with R being defined as above; and R₂ is a hydrogen or methyl moiety, preferably hydrogen and (ii) a glycerine alkoxylate represented by formula (I) wherein R₁ is hydrogen and R₂ is a hydrogen or methyl moiety, preferably hydrogen. In this instance, when the alcohol alkoxylate polymer is a mixture, advantageously the glyceride ester component is present in from about 60 to 90 weight percent, preferably 70 to 80 weight percent, and the glycerine alkoxylate component is present in from 10 to 40 weight percent, preferably from 20 to 30 weight percent, based on total weight of the alcohol alkoxylate polymer present.

When the alcohol alkoxylate polymer comprises the glyceride ester, the ester itself, by virtue of its method of preparation, is generally a blend of mono-, di- and tri-ester glycerides wherein the mole ratio of said mono-, di- and tri-esters is typically 45-90:10-30:1-15 respectively.

The method of preparing glyceride esters suitable for the present invention is well known to the person skilled in the art and generally consists of the transesterification of fatty acid esters such as present in a seed oil with an alcohol under basic conditions. In the present invention such alcohol is a glycerine alkoxylate as described hereinabove and as represented by formula (I). Preferably the glycerine alkoxylate used to prepare the glyceride ester is represented by formula (I) and wherein R₁ is hydrogen and R₂ is hydrogen. Such preferred glycerine alkoxylate transesterification agents are well known in the art and can be obtained by reaction of glycerine with ethylene oxide and/or propylene oxide under basic conditions.

The methods for the preparation of glyceride esters are well known to the person skilled in the art and described for example in the publications, U.S. Pat. No. 5,403,509 or U.S. Pat. No. 7,989,411, both incorporated herein by reference for all purposes. In the present disclosure, the inventors have of preference chosen sustainable vegetable seed oils including sunflower oil, canola oil, corn oil, coconut oil, palm oil, soybean oil, hemp oil, and castor oil. Coconut oil and soybean oil are preferred due to an observed ability to impart a gloss result in the end application. Soybean oil is generally recognized as being a fatty acid ester of predominantly linoleic acid (C-18) and minor amounts of oleic acid (C-18) and palmitic acid (C-16); coconut oil being a fatty acid ester of mainly lauric acid (C-12) and a lesser amount of myristic acid (C-14). Full composition details of the various seed oils are well known in the literature, see for example descriptions provided in the Kirk-Othmer Encyclopedia of Chemical Technology, incorporated herein by reference for all purposes.

Use of the hereinabove defined composition is facilitated if the composition further contains an additional liquid component or solvent to facilitate transfer in the end application. The liquid can be an organic liquid, for example a light hydrocarbon or lower alcohol, for example glycerine, or preferably water. When present the liquid comprises from 40 to 80 weight percent of the total weight of the composition including the alcohol alkoxylate component.

Of convenience, the composition of the invention as described herein above can be stored, optionally in the presence of the additional liquid component, in a plastic bottle or an aerosol dispenser unit; optionally fitted with a dispensing device.

As mentioned, one of the primary uses intended for the above-described composition is as a gloss enhancing agent for exposed/visible elastomeric surfaces and notably those of rubber-based elastomers such as found in the sidewall of tyres, especially pneumatic tyres as associated with transportation and particularly automobiles. In this instance, the composition as disclosed hereinabove provides for a method of use, the method comprising:
cleaning a target tyre sidewall;
applying a thin film coating of the composition on said tyre sidewall and allowing the surface to dry, and optionally applying a second coating of the composition to the tyre sidewall.

To facilitate a better understanding of the present disclosure the following examples of preferred or representative embodiments are given. In no way should the following examples be read to limit, or to define, the scope of the invention.

The combined gloss index of the various compositions has been determined by projecting a beam of light at a fixed intensity and angle onto a surface and measuring the amount of reflected light at an equal but opposite angle with a 20/60/85° gloss meter for matte to mirror finishes. Test procedure ASTM D523 was followed as a Standard Test Method for Specular Gloss. Haze measurements were taken in accordance with the ASTM E430 procedure.

Glycine alkoxylate adducts were prepared in a stirred batch reactor to react glycerine with ethylene oxide (“EO”) in the presence of a catalyst according to the details given in Table 1 below. The reaction was conducted under a nitrogen atmosphere (8 psi, and at a temperature of 175° C.). The catalyst was the Sasol proprietary ethoxylation catalyst system as developed by Sasol (USA) Corporation and as disclosed in U.S. Pat. Nos. 4,775,653; 4,835,321; 5,220,077; 5,626,121; 8,329,609 and 9,802,879, the disclosures of which are all incorporated herein by reference for all purposes.

### Examples

TABLE 1
Preparation of Glycerine Alkoxylate Adducts

| | Starter | Alkylene | | |
|---|---|---|---|---|
| G-AO | molecule | oxide | Catalyst | |
| Adduct | (pbw) | (pbw) | (pbw) | Description |
| 1 | Glycerine | EO | Catalyst | Gly-15EO |
| | pbw: 612 | pbw: 4388 | pbw: 7.5 | R₁ = hydrogen, |
| | | | | R₂ = hydrogen, |
| | | | | Sum X = 15 |
| 2 | Glycerine | EO | Catalyst | Glycerine-50EO |
| | pbw: 45 | pbw: 965 | pbw: 1.5 | R₁ = hydrogen, |
| | | | | R₂ = hydrogen, |
| | | | | Sum X = 50 |

Glyceride ester adducts were prepared by transesterification of a seed oil with a glycerine alkoxylate under base conditions, KOH (aq 40%), according to the details given in Table 2. It will be appreciated that the acyl group is derived from the seed oil and thus reflects the compositional make up of the respective seed oil. The reaction was conducted in a stirred batch reactor by first treating the glycerine alkoxylate with the base under a nitrogen purge for approximately 1 hour at 120° C. followed by dropwise addition while stirring, over a period of about 1 hour and at a temperature 100° C. of the seed oil. The resulting glyceride ester was then reduced in temperature to 80 C° and neutralized by the addition of formic acid.

TABLE 2
Preparation of Glyceride Ester Adducts

| | Seed | Transesteri- | | Formic | |
|---|---|---|---|---|---|
| G-Est | Oil | fication | Base | Acid | |
| Adduct | (pbw) | alcohol (pbw) | (pbw) | (pbw) | Description |
| 1 | Soybean | Gly-15EO | 5 | 5 | SOE-15 |
| | oil | pbw: 350 | | | R₁ = acyl, |
| | pbw: 150 | | | | R₂ = hydrogen, |
| | | | | | Sum X = 15 |
| 2 | Coconut | Gly-50EO | 5 | 5 | CNOE-50 |
| | oil | pbw: 350 | | | R₁ = acyl, |
| | pbw: 150 | | | | R₂ = hydrogen, |
| | | | | | Sum X = 50 |

Various compositions/systems were applied onto identical tyre specimens. The tyre composition was applied to a piece of a used lawn mower golf cart tyre size: 18/8.50/8 sidewall rubber. The tyre composition was left to dry and/or adsorb the composition for two (2) hours in well ventilated space. Twenty-degree (20°), Sixty-degree (60°), and Eighty-five (85°) gloss ratings were taken in triplicate with a BYK Handheld Tri-Gloss-Meter. The results were averaged and summed to get a “Combined Gloss Index”. A higher gloss index value generally equates to a better performance and a more desirable “wet look”.

The compositions are detailed in Table 3 along with their observed combined gloss index.

TABLE 3

| Components (pbw) | System 1 | System 2 | System 3 | System 4 |
|---|---|---|---|---|
| Gly-15EO | 20 | | | |
| Gly-50EO | | | | 40 |
| SOE-15 | | 20 | | |
| CNOE-50 | | | 40 | |
| Soybean oil | | 30 | | |
| Glycerine | 30 | | | |
| Linear paraffin solvent | | 50 | | |
| Distilled water | 50 | | 60 | 60 |
| Combined Gloss Index | 46.5 | 52.6 | 57.1 | 34.4 |

By way of comparison, a selection of commercially available tyre-dressing compositions containing between twenty percent (20%) to fifty percent (50%) by weight silicone in solvent mixtures were similarly evaluated and observed as having a combined gloss indices of 18, 42, 98 and 138. The higher the silicone oil content generally the higher the gloss index. The combined gloss index for the compositions/system reported in this disclosure clearly demonstrate that tyre-dressing compositions of acceptable performance can be obtained in the absence of a silicone oil.

1. A tyre dressing composition intended for use in a tyre dressing method, said composition comprising an alcohol alkoxylate polymer corresponding to formula (1): 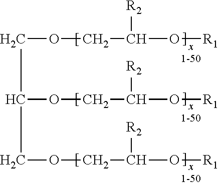
wherein R₁ represents a hydrogen atom or an acyl moiety (—CO—R)
where R is an alkyl or alkenyl group moiety constituted by at least 6, and up to 18 carbons atoms; R₂ represent a hydrogen atom, methyl (—CH₃) or ethyl (—CH₂CH₃) moiety; and each X independently represents an integer of from 1 to 50 and wherein the sum of all X present is from 1 to 100.

2. The composition of claim 1 wherein the alcohol alkoxylate polymer comprises a glycerine alkoxylate represented by formula (1) wherein R₁ is hydrogen and R₂ is a hydrogen or methyl moiety.

3. The composition of claim 1 wherein the alcohol alkoxylate polymer comprises a glyceride ester represented by formula (1) when at least at least one R₁ is an acyl moiety (—CO—R); and R₂ is a hydrogen or methyl moiety.

4. The composition of claim 1 wherein the alcohol alkoxylate polymer is a mixture comprising (i) a glyceride ester represented by formula (1) when at least at least one R₁ is an acyl moiety (—CO—R); and R₂ is a hydrogen or methyl moiety and (ii) a glycerine alkoxylate represented by formula (1) wherein R₁ is hydrogen and R₂ is a hydrogen or methyl moiety.

5. The composition of claim 4 wherein the glyceride ester component is present in from about 60 to 90 weight percent, and the glycerine alkoxylate component present in from 10 to 40 weight percent, based on total weight of the alcohol alkoxylate polymer present.

6. The composition of claim 4 wherein the glyceride ester is a mixture of mono-, di- or tri-ester glycerides.

7. The composition of claim 6 wherein the weight ratio of said mono-, di- and tri-esters is from 45-90:10-30:1-15 respectively.

8. The composition of claim 4 wherein for the glyceride ester component, the R₂ moiety is hydrogen, and the sum of all X present is an integer of from 10-60.

9. The composition of claim 1 wherein in the sum of all X present in formula (1) is an integer of from 5-80.

10. The composition of claim 3 wherein the glyceride ester is obtained by transesterification of a seed oil with a glycerine alkoxylate represented by formula (1) and where R₁ is hydrogen, R₂ represent a hydrogen atom or methyl moiety.

11. The composition of claim 4 wherein the glyceride ester is obtained by transesterification of a seed oil with a glycerine alkoxylate represented by formula (1) and where R₁ is hydrogen, R₂ represent a hydrogen atom or methyl moiety.

12. The tyre composition of claim 10 wherein the glycerine alkoxylate used in the transesterification is represented by formula (1) where R₁ is hydrogen, R₂ represent a hydrogen atom; and the sum of all X present is from an integer from 10 to 60.

13. The tyre composition of claim 11 wherein the glycerine alkoxylate used in the transesterification is represented by formula (1) where R₁ is hydrogen, R₂ represent a hydrogen atom; and the sum of all X present is from an integer from 10 to 60.

14. The tyre dressing composition of claim 10 wherein the seed oil is sunflower oil, canola oil, soybean oil, coconut oil, corn oil, palm oil, hemp oil, and/or castor oil.

15. The tyre dressing composition of claim 11 wherein the seed oil is sunflower oil, canola oil, soybean oil, coconut oil, corn oil, palm oil, hemp oil, and/or castor oil.

16. The composition of claim 1 further comprising water present in from 40 to 80 weight percent based on total weight of the composition.

17. The composition of claim 1 further comprising an organic liquid present in from 40 to 80 weight percent based on total weight of the composition.

18. The composition of claim 1, wherein the composition is stored in a plastic bottle or in an aerosol disperser unit.

19. A method of dressing a tyre, the method comprising:
providing a composition as claimed in claim 1;
cleaning a target tyre sidewall;
applying a thin film coating of the composition on said tyre sidewall and allowing the surface to dry.
